(19) United States
(12) Patent Application Publication
(10) Pub. No.: US 2020/0245754 A1
(43) Pub. Date: Aug. 6, 2020

(54) METHOD AND APPARATUS FOR END ROUNDING BRISTLES

(71) Applicant: TePe Munhygienprodukter AB, MALMÖ (SE)

(72) Inventor: Jan-Inge Larsson, Veberöd (SE)

(73) Assignee: TePe Munhygienprodukter AB, MALMÖ (SE)

(21) Appl. No.: 16/791,342

(22) PCT Filed: Aug. 16, 2018
(86) PCT No.: PCT/SE2018/050830

§ 371 Date: Feb. 14, 2020

(30) Foreign Application Priority Data
Aug. 17, 2017 (SE) 1751003-3

(51) Int. Cl. A46D 1/00; A46D 1/04; A46D 9/00; B23K 26/08; B23K 26/082; B23K 26/38; B23K 26/06; A61C 15/00

(52) U.S. Cl. CPC A46D 1/0284; A46D 1/04; A46D 9/00; B23K 26/0823; B23K 2101/20; B23K 26/38; B23K 26/0665; A61C 15/00; A46B 2200/108; B23K 26/082

(57) ABSTRACT

A method for end rounding bristles of a brush section includes providing a focused laser beam propagating along a geometrical main propagation direction and having a main irradiation spot, providing a relative motion between an end of each bristle and the main irradiation spot of the focused laser beam such that the end of each bristle is moved through the main irradiation spot in a path having a main component transverse to a longitudinal extension of the bristle, wherein the focused laser beam is directed such that the geometrical main propagation direction has a main component transverse to the longitudinal extension of respective bristle having its end at the main irradiation spot, whereby a rounding of the end is provided by the focused laser beam heating the end and causing it to partly melt and form a rounded end, and providing a relative motion between the main irradiation spot and the brush section along a direction having a main component being transverse to the path, thereby subjecting in sequence the ends of the plurality of bristles to the focused laser beam thereby providing a brush section having end rounded bristles. The disclosure also relates to an apparatus.

### FIELD OF INVENTION

The invention relates to a method for end rounding bristles of a brush section, preferably a brush section of an interdental brush.

The invention also relates to an apparatus for end rounding bristles of a brush section comprising a plurality of bristles.

### TECHNICAL BACKGROUND

It is preferred that the toothbrush bristle ends are free of sharp or jagged edges to reduce the risk of unwanted gingival and dental abrasion.

Through the years there has been proposed a number of different approaches to provide bristle ends that are free of sharp or jagged edges.

EP 0060592 B1 published in 1985 discloses a brush provided with bristles made of an organic thermoplastic synthetic material such as nylon, particularly a tooth-brush. The free ends of the bristles which are sharp and therefore able to damage soft surfaces are rounded by a heat treatment. The bristle ends are submitted to a laser beam treatment. It discloses that the bristle ends extend downwardly and that the source of laser beams is placed below the bristle ends. The brush and the heat source are submitted to a relative movement and the heat treatment takes place in an atmosphere of an inert gas. It may be noted that this set-up relies on a laser being focused with precision on the bristle ends in order to secure that excessive heat is not provided to other parts of the brush.

U.S. Pat. No. 4,762,373 published in 1988 discloses a method for rounding the bristle tips of toothbrushes by the action of laser radiation, wherein the rounding process is effected in an electrostatic field. It is explained that this will avoid fusion of the individual bristles as well as formation of a mushroom-like bristle tip. It may be noted that providing an electrostatic field adds a difficulty and is often not desired in today's highly computerized manufacturing facilities to have electrostatic fields. It may be noted that also this set-up relies on a laser being focused with precision on the bristle ends in order to secure that excessive heat is not provided to other parts of the brush.

U.S. Pat. No. 5,007,686 published in 1991 discloses at method in which controlled melting of the tips of bristles is achieved by using a pulsed laser beam operating in the kilowatt range and having a pulse duration in the micro-second range. It may be noted that also this set-up relies on a laser being focused with precision on the bristle ends in order to secure that excessive heat is not provided to other parts of the brush.

It may also be noted that none of the laser based methods are useful for so-called interdental brushes.

U.S. Pat. No. 5,015,504 published in 1991 discloses that the ends of bristles of a brush, e.g. a toothbrush, are treated with a polysiloxane prepolymer which is then cured. The treated bristles are smooth and round-ended.

U.S. Pat. No. 5,653,628 published in 1997 discloses a device for rounding the ends of plastic bristles on rotationally symmetrical circular brushes has a tool in the form of a rotationally symmetrical hollow body with an abrasive inner surface, which has an inner contour with an at least zonally smaller cross-section than the circular brush corresponding to the outer contour of the latter and between the circular brush and the tool there is a relative rotary movement and a reversible relative axial movement.

Thus, there have been a number of different methods proposed to provide end rounding of bristles of brushes. However, as will be apparent from the discussion below, there is still room for improvements.

### SUMMARY OF INVENTION

It is an object of the invention to provide a new and improved method for end rounding bristles. It is also an object to provide a new and improved method which is especially suitable for or at least easily adapted for end rounding bristles of a brush section of an interdental brush.

These objects have been achieved by a method for end rounding bristles of a brush section comprising a plurality of bristles, the method comprising

providing a focused laser beam propagating along a geometrical main propagation direction and having a main irradiation spot,

providing a relative motion between an end of each bristle and the main irradiation spot of the focused laser beam such that the end of each bristle is moved through the main irradiation spot in a path having a main component transverse to a longitudinal extension of the bristle, wherein the focused laser beam is directed such that the geometrical main propagation direction has a main component transverse to the longitudinal extension of respective bristle having its end at the main irradiation spot, whereby a rounding of the end is provided by the focused laser beam heating the end and causing it to partly melt and form a rounded end,

providing a relative motion between the main irradiation spot and the brush section along a direction having a main component being transverse to the path, thereby subjecting in sequence the ends of the plurality of bristles to the focused laser beam thereby providing a brush section having end rounded bristles.

By directing the focused laser beam such that it has a main component transverse to the longitudinal direction of the respective bristle at the main irradiation spot and by providing a relative motion between the end of the bristle and the main irradiation spot such that the bristle end moves through the main irradiation spot in a path having a main component transverse to the longitudinal extension of the bristle, it is compared to the prior art solutions easier to secure that each end is subjected to the desired amount of heat and at the desired height of the bristles without risking to affect other parts of the bristles. With the inventive set-up it is e.g. possible to use comparably high powered laser beam and move the bristles through the main irradiation spot quickly, thereby making it possible to speed-up the process, without risking to damage other parts of the bristles or brush section. It may be noted that with the inventive set-up it has become possible to adjust a number of parameters, such as the laser effect, the degree of focus, the speed of the relative motion along the path, independently from each other without causing any problem to any other part of the bristle or brush section. Thereby is it easier to tune the different parameters to get the desired amount of heat to the bristle ends. Moreover, it is easier to tune the parameters to get a desired heating profile over time.

It may be noted that the path may have a main component transverse to the geometrical main propagation direction. This would e.g. be the case with an interdental brush section rotating about a longitudinal axis of the brush section and the focused laser beam being oriented with the geometrical main propagation mainly parallel to the to the longitudinal axis.

It may be noted that the path may have a main component along the geometrical main propagation direction. This would e.g. be the case with an interdental brush section rotating about a longitudinal axis of the brush section and the focused laser beam being oriented with the geometrical main propagation mainly along the tangential direction.

It may be noted that the relative motion between the main irradiation spot and the brush section may according to one embodiment be along a direction having a main component being transverse to the geometrical main propagation direction and transverse to the path. This would e.g. be the case with an interdental brush section rotating about a longitudinal axis of the brush section and the focused laser beam being oriented with the geometrical main propagation mainly along the tangential direction and the relative motion between the main irradiation spot and the brush section mainly being directed along the longitudinal axis of the brush section.

It may be noted that the relative motion between the main irradiation spot and the brush section may according to another embodiment be along a direction having a main component along the geometrical main propagation direction and transverse to the path. This would e.g. be the case with an interdental brush section rotating about a longitudinal axis of the brush section and the focused laser beam being oriented with the geometrical main propagation mainly along the tangential direction and the relative motion between the main irradiation spot and the brush section being directed along the longitudinal axis of the brush section, e.g. being performed by relative movement of the laser and/or brush section and/or by changing the focal distance of the laser.

It may be noted that a laser as such may be said to have a focus spot which is related to the laser as such. When a laser is used in the method disclosed in this application, there will be a spot where the maximum amount of energy is applied to a bristle. This spot where the maximum amount of energy is applied is denoted the main irradiation spot. It is preferred that the laser is positioned in the system such that the resulting main irradiation spot coincides with the focus spot of the laser.

It may be noted that the brush section may be a separate brush section e.g. only comprising a stem and bristles at the time for the end rounding. Alternatively, the brush section may during end rounding already be a part of a more or less complete brush.

Preferred embodiments appear in the dependent claims and in the description.

The method may further comprise end cutting respective bristle by a mechanical cutter before rounding of the end.

Mechanical cutters are a proven technology and may e.g. entail rotating an interdental brush section against a knife edge, such as a razor blade or the like.

The method may further comprise end cutting respective bristle by means of a focused laser beam before rounding of the end.

Considering that the method involves a laser for end rounding it is convenient to use the same laser or another laser to end cut the bristles, since the manufacturing machine and the general environment, including e.g. safety systems, power supply, control systems, etc., already are designed for use of a laser. Laser cutting before end rounding may e.g. be performed by moving a laser along the longitudinal axis of a rotating interdental brush section, with the laser being configured to end cut the bristles, where after the same or another laser is moved along the longitudinal axis of the rotating interdental brush section, with the laser now being configured to performing end rounding of the ends.

The method may further comprise end cutting respective bristle by means of a focused laser beam while the end is heated to be rounded. This may be performed in a number of different manners. The degree of focus and maximum intensity could e.g. be chosen such that, when an interdental brush section is rotated about a longitudinal axis of the brush section and the focused laser beam being oriented with the geometrical main propagation mainly along the tangential direction, the bristle is heated before, during and/or after passage through the main irradiation spot to accomplish end rounding and that the bristle is cut during passage through the main irradiation spot.

The method may further comprise positioning the brush section in a first fixture and keeping the brush section in the first fixture during both the end cutting and the end rounding of the ends. Thereby it is easier to secure that the ends are positioned at the intended position when the laser provides the heat for the end rounding. It may be noted that the first fixture is intended to denote the fixture actually interacting with and holding the brush section. The first fixture may be moved from an end cutting position to an end rounding position, but since the first fixture maintains its grip on the brush section any misplacement of the brush section relative to the fixture at the end rounding position is eliminated. In a preferred embodiment, the first fixture also interacts with and holds the brush section during twisting of the stem to fixate the bristles to the stem.

The method may be adapted for end rounding bristles of an interdental brush or an interdental brush section, and especially an interdental brush having an interdental brush section comprising a brush stem extending along a longitudinal axis and a plurality of bristles supported by the stem and extending from the stem in a mainly radial direction. Thereby the method may also be said to include a step of providing an interdental brush section comprising a brush stem extending along a longitudinal axis and a plurality of bristles supported by the stem and extending from the stem in a mainly radial direction. It may be noted that the end rounding may be performed after the interdental brush has been completed or assembled into an interdental brush or that the end rounding may be performed on an interdental brush section, such as an interdental brush section comprising a brush stem extending along a longitudinal axis and a plurality of bristles supported by the stem and extending from the stem in a mainly radial direction, before the interdental brush section has been assembled or integrated into other parts forming, together with the interdental brush section, the complete interdental brush.

The method may further comprise

providing an interdental brush section comprising a brush stem extending along a longitudinal axis and a plurality of bristles supported by the stem and extending from the stem in a mainly radial direction,

wherein the step of providing a relative motion between an end of each bristle and the main irradiation spot of the focused laser beam, comprises rotating the brush section about the longitudinal axis such that an end of each bristle sweeps around the longitudinal axis in a circular path in which circular path the end passes the main irradiation spot,

wherein the step of providing a relative motion between the main irradiation spot and the brush section, comprises providing a relative motion of the main irradiation spot along the longitudinal axis thereby subjecting the ends of the plurality of bristles to the focused laser beam in sequence thereby providing a brush section having end rounded bristles.

Rotation of such an interdental brush section is a convenient manner of giving each bristle the desired path through the main irradiation spot. Moreover, the manufacturing devices used today typically comprises equipment for rotating an interdental brush section or interdental brush, thereby making implementation easy.

Moving the irradiation spot along the longitudinal axis during rotation of the interdental brush section is a convenient manner of securing that every bristle end is end rounded. The relative motion of the main irradiation spot along the longitudinal axis may be accomplished in a number of different ways. The laser as such may be moved. The focused laser beam may be redirected by tilting the laser or more preferably by tilting the optics or a mirror in the laser. The brush or brush section may be moved. Of course are also combinations of these methods conceivable. The relative motion may also be accomplished in other ways.

The method may further comprise directing the focused laser beam such that the geometrical main propagation direction forms an angle of up to about and including 45° relative to a tangent of the circular path in the main irradiation spot. It may be noted that the focused laser beam may thus be tilted in any direction relative to the tangent as long as the angle formed between the tangent and the geometrical main propagation direction is up to about 45°. It may be noted that the main propagation direction may be along or may be opposite the tangent of the path. The conceivable angles may thus be said to be within an hour glass shaped double cone with the cone walls forming an angle of 45° to the centre line of the cones. By orienting the focused laser beam in this mainly tangential direction it is easy to move the irradiation sport along the longitudinal direction. Moreover, the orientation also makes it is easy to orient the laser to provide pre-heating and/or after-heating of the bristle ends. Moreover, the orientation also makes it is easy to provide end rounding, and optionally also end cutting, of bristles having different lengths. Bristles having different lengths may be used to provide a curved profile of the geometrical envelope surface formed by the bristle ends.

The method may further comprise end cutting respective bristle by means of a focused laser beam by providing a relative motion of the focused laser beam along the longitudinal axis thereby end cutting the plurality of bristles before providing a relative motion of the focused laser beam along the longitudinal axis for rounding of the ends.

The focused laser beam may have a maximum intensity of 10-20000 W/mm² at the geometrical focus spot. The intensity is typically provided as a characteristic of the laser as such. In the method, the main irradiation spot may refer to a spot including the geometrical focus spot but being a slightly larger spot than the geometrical focus spot. The main irradiation spot may e.g. relate to a spot having an intensity of at least 90%, preferably at least 95%, of the intensity at the geometrical focus spot.

The method may further comprise focusing the focused laser beam to a main irradiation spot having an area of 0.01 to 1.0 mm². Thereby a well-defined main irradiation point may be accomplished.

The method may further comprise focusing the focused laser beam to a main irradiation spot having, in a plane transverse to the geometrical main propagation direction, a maximum width being less than three, preferably less than two times a width in a direction orthogonal to the maximum width. Thereby a well-defined main irradiation spot may be accomplished. The main irradiation spot may typically be circular as seen along the focused laser beam.

The method may further comprise focusing the focused laser beam to a focus depth of between 100 to 10000 μm. The focus depth may be defined as a distance measured along the geometrical main propagation direction between the two planes, on either side of the geometrical focus spot along the propagation direction, at which the intensity per surface area is 95% of the intensity per surface area at the geometrical focus spot. Thereby a well-defined main irradiation point may be accomplished.

The method may further comprise subjecting respective bristle end to the focused laser beam for a time period being between 100-100000 μs, thereby heating the end and causing it to partly melt. This time interval is considered suitable to be able to provide sufficient heat at a reasonable intensity to accomplish the desired partial melting.

The laser may be of any suitable kind. It may e.g. be a Nd:YAG-laser, such as lamp or diode pumped Nd:YAG-laser. It may e.g. be a continuous Nd:YAG-laser. It may e.g. be a fibre laser such as a Ytterbium fibre laser. It may e.g. be a high power diode laser. It may e.g. be a CO₂ laser.

The above objects have also been achieved by an apparatus for end rounding bristles of a brush section comprising a plurality of bristles, the apparatus comprising:

a laser comprising a laser beam source and optics configured to provide a focused laser beam propagating along a geometrical main propagation direction and having a main irradiation spot,

a fixture for holding a brush section comprising a plurality of bristles, wherein the fixture is configured to provide a relative motion between an end of each bristle and the main irradiation spot of the focused laser beam such that the end of each bristle is moved through the focused laser beam at the main irradiation spot in a path having a main component transverse to a longitudinal extension of the bristle,

wherein the focused laser beam is directed such that the geometrical main propagation direction has a main component transverse to the longitudinal extension of respective bristle having its end at the main irradiation spot, whereby a rounding of the end is provided by the focused laser beam heating the end and causing it to partly melt and form a rounded end, and

wherein the apparatus is configured to provide a relative motion between the main irradiation spot and the brush section along a direction having a main component being transverse to the path, thereby subjecting the ends of the plurality of bristles to the focused laser beam in sequence thereby providing a brush section having end rounded bristles.

By directing the focused laser beam such that it has a main component transverse to the longitudinal direction of the respective bristle at the main irradiation spot and by providing a relative motion between the end of the bristle and the main irradiation spot such that the bristle end moves through the main irradiation spot in a path having a main component transverse to the longitudinal extension of the bristle, it is compared to the prior art solutions easier to secure that each end is subjected to the desired amount of heat and at the desired height of the bristles without risking to affect other parts of the bristles. With the inventive set-up it is e.g. possible to use comparably high powered laser beam and move the bristles through the main irradiation spot quickly, thereby making it possible to speed-up the process, without risking to damage other parts of the bristles or brush section. It may be noted that with the inventive set-up it has become possible to adjust a number of parameters, such as the laser effect, the degree of focus, the speed of the relative motion along the path, independently from each other without causing any problem to any other part of the bristle or brush section. Thereby is it easier to tune the different parameters to get the desired amount of heat to the bristle ends. Moreover, it is easier to tune the parameters to get a desired heating profile over time.

It may be noted that the path may have a main component transverse to the geometrical main propagation direction. This would e.g. be the case with an interdental brush section rotating about a longitudinal axis of the brush section and the focused laser beam being oriented with the geometrical main propagation mainly parallel to the to the longitudinal axis.

It may be noted that the path may have a main component along the geometrical main propagation direction. This would e.g. be the case with an interdental brush section rotating about a longitudinal axis of the brush section and the focused laser beam being oriented with the geometrical main propagation mainly along the tangential direction.

It may be noted that the relative motion between the main irradiation spot and the brush section may according to one embodiment be along a direction having a main component being transverse to the geometrical main propagation direction and transverse to the path. This would e.g. be the case with an interdental brush section rotating about a longitudinal axis of the brush section and the focused laser beam being oriented with the geometrical main propagation mainly along the tangential direction and the relative motion between the main irradiation spot and the brush section mainly being directed along the longitudinal axis of the brush section.

It may be noted that the relative motion between the main irradiation spot and the brush section may according to another embodiment be along a direction having a main component along the geometrical main propagation direction and transverse to the path. This would e.g. be the case with an interdental brush section rotating about a longitudinal axis of the brush section and the focused laser beam being oriented with the geometrical main propagation mainly along the tangential direction and the relative motion between the main irradiation spot and the brush section being directed along the longitudinal axis of the brush section, e.g. being performed by relative movement of the laser and/or brush section and/or by changing the focal distance of the laser.

The fixture may be configured to rotate the brush section about a longitudinal axis such that an end of each bristle sweeps around the longitudinal axis in a circular path.

The laser may be oriented relative to the fixture such that the focused laser beam becomes directed towards the bristles of a brush section in the fixture such that an end of respective bristle sweeping in the circular path passes the main irradiation spot.

The apparatus may be configured to provide a relative motion between the fixture and the main irradiation spot along the longitudinal axis such that the laser beam becomes directed towards the respective end of the plurality of bristles in sequence.

The features of the different embodiments of the method is equally applicable as different embodiments of the apparatus.

The method and/or apparatus may further comprise the focused laser beam being directed at an angle relative to the tangent such that a greater amount of energy from the laser beam is applied to the bristle before the bristle reaches the main irradiation spot than the amount of energy applied to the bristle after the bristle has passed the main irradiation spot. This may be referred to as a pre-heating the bristle ends.

The method and/or apparatus may further comprise the focused laser beam being directed at an angle relative to the tangent such that a smaller amount of energy from the laser beam is applied to the bristle before the bristle reaches the main irradiation spot than the amount of energy applied to the bristle after the bristle has passed the main irradiation spot. This may be referred to as an after-heating the bristle ends.

### BRIEF DESCRIPTION OF THE DRAWINGS

The invention will by way of example be described in more detail with reference to the appended schematic drawings, which shows a presently preferred embodiment of the invention.

FIG. 1a is a plan view of an interdental brush.

FIG. 1b is a plan view of an interdental brush according to another embodiment in which the bristle ends have different lengths such that the geometrical circular envelope surface has a curved profile along the longitudinal direction.

FIG. 1c is a plan view of a brush section.

FIG. 2 is a side view of a laser irradiating a bristle end.

FIG. 3 is an enlargement of FIG. 2.

FIG. 4 is a second side view of the set-up in FIG. 2.

FIG. 5 is a plan view of an apparatus including the set-up of FIGS. 2-4.

FIG. 6 is a set-up providing after-heating.

FIG. 7 is a set-up providing pre-heating.

FIG. 8 is a diagram of a method for end rounding bristles of a brush section.

FIG. 9 is a schematic drawing of an end rounded bristle.

### DETAILED DESCRIPTION OF PREFERRED EMBODIMENTS

The method and apparatus for end rounding bristles are especially configured for end rounding of bristles of a brush section for an interdental brush

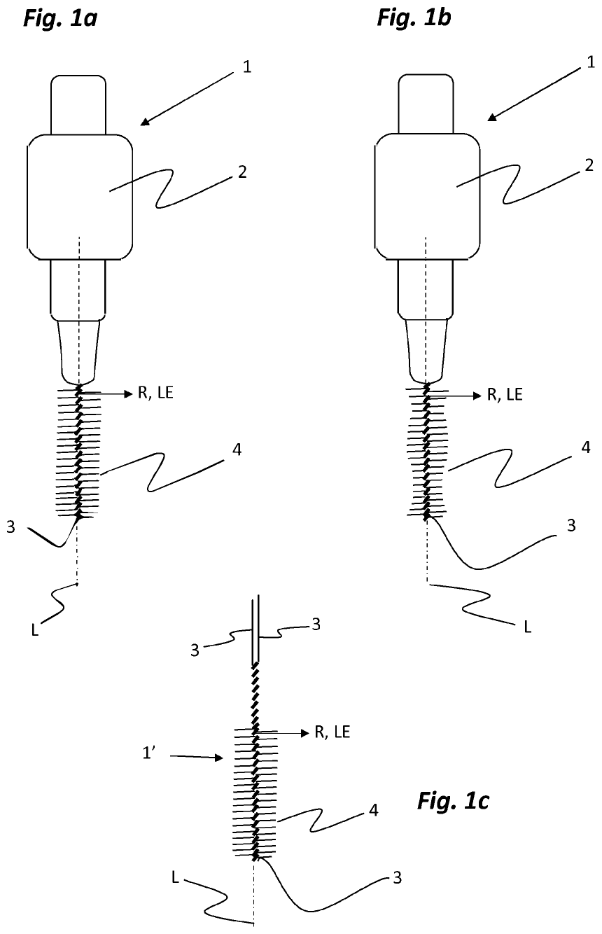

In FIG. 1a and FIG. 1b, there is shown a typical interdental brush 1 according to a first and a second embodiment. The interdental brush 1 comprises a handle 2, from which a brush stem 3 extends along a longitudinal axis L. The brush stem 3 may be formed of a twisted metal wire, which preferably is coated with a protective polymer coating. The brush stem 3 supports a plurality of bristles 4. The respective bristle 4 extends from the stem in a mainly radial direction R. This may also be said that the elongate bristles 4 extend with their longitudinal extension LE in the radial direction R. The stem 3 extends into the interior of the handle 2 and is attached to the handle 2. This is indicated by the dashed line extending from the visible part of the stem 3 into the handle 2. The attachment may e.g. be accomplished by the stem 3 being clamped between two halves of the handle 2 or by the handle 2 being moulded with the stem 3 inserted into the moulding cavity defining the handle 2. The stem 3 with the bristles 4 may be referred to as a brush section 1′ as shown in FIG. 1c. The stem 3 may be twisted along its complete length, only along the distance where it supports the bristles 4, or it may, as is indicated in FIG. 1c, be twisted a distance slightly longer than the part the supports the bristles 4 and then the final inner most part of the stem 3 is not twisted and the two strands of the stem 3 extends in parallel with each other.

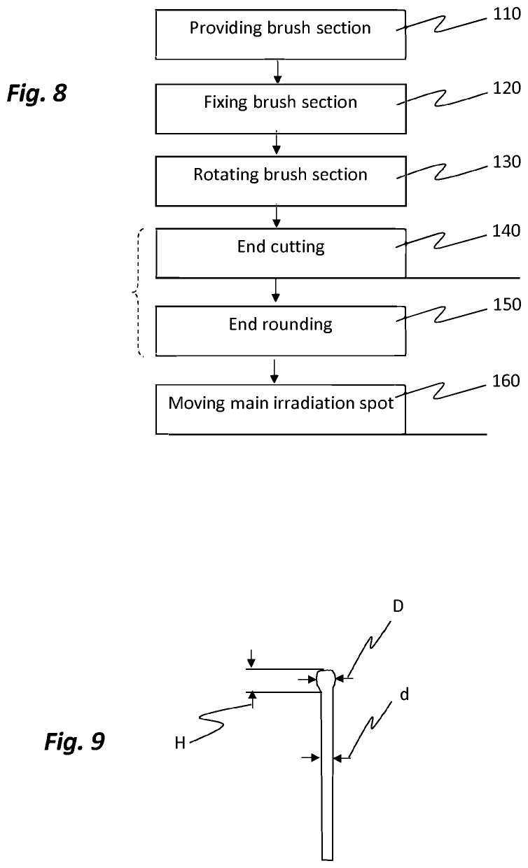

The ends of the bristles 4 are end rounded. This is in accordance with a preferred embodiment accomplished by a method which in short with reference to FIG. 8 may be said to include

providing 110 a brush section, such as an interdental brush section,

fixing 120 the brush section 1′, such as in a first fixture 21,

rotating 130 the brush section,

end cutting 140 the bristles,

end rounding 150 the bristle ends, and

moving 160 a main irradiation spot of a laser 10 along the longitudinal direction L.

It may be noted that it is preferred that the end rounding is performed on a brush section 1′ basically being formed of the stem 3 and the bristles 4. However, the method is equally applicable to a finished brush 1 or to any intermediate state between a brush section 1′ being formed of a stem 3 and bristles 4 and a finished brush 1.

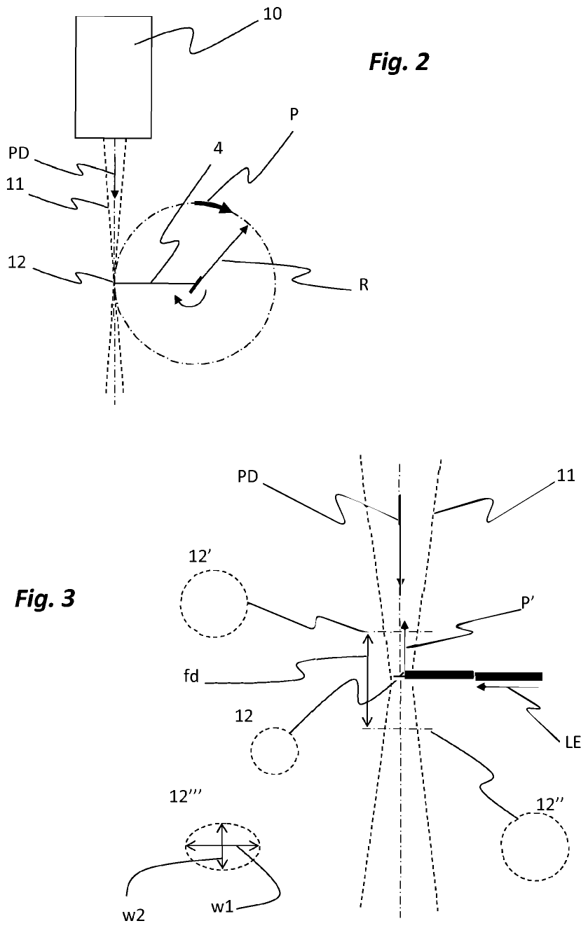

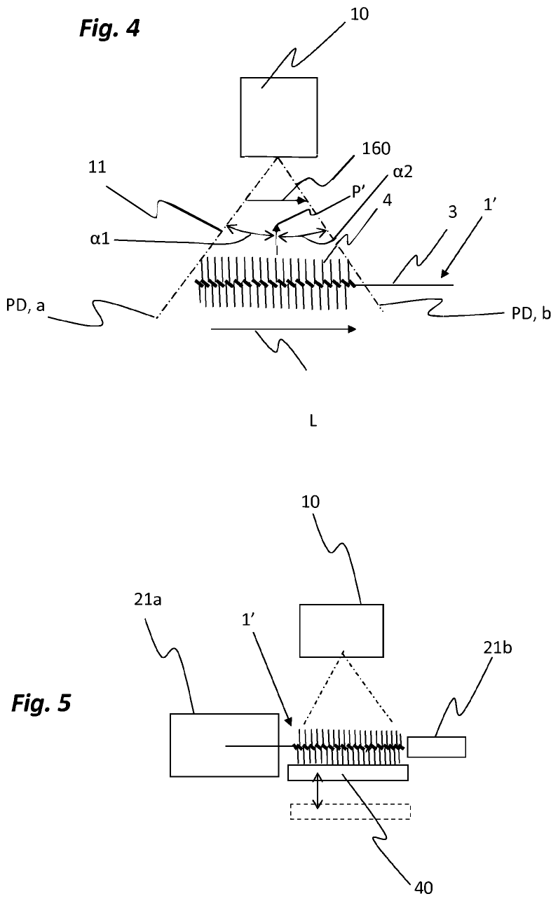

The end rounding is performed using a focused laser beam 11 propagating along a geometrical main propagation direction PD and having a main irradiation spot 12 as shown in FIG. 2 and the enlargement in FIG. 3.

By rotating 130 the brush section 1′ about the longitudinal axis L there is provided a relative motion between an end of each bristle 4 and the main irradiation spot 12 of the focused laser beam 11. The rotation 130 will cause an end of each bristle 4 sweeping around the longitudinal axis L in a circular path P in which circular path P the end passes the main irradiation spot 12. It may be noted that this will result in that the end of each bristle 4 is moved through the main irradiation spot 12 in a path P having a main component transverse to a longitudinal extension LE of the bristle 4.

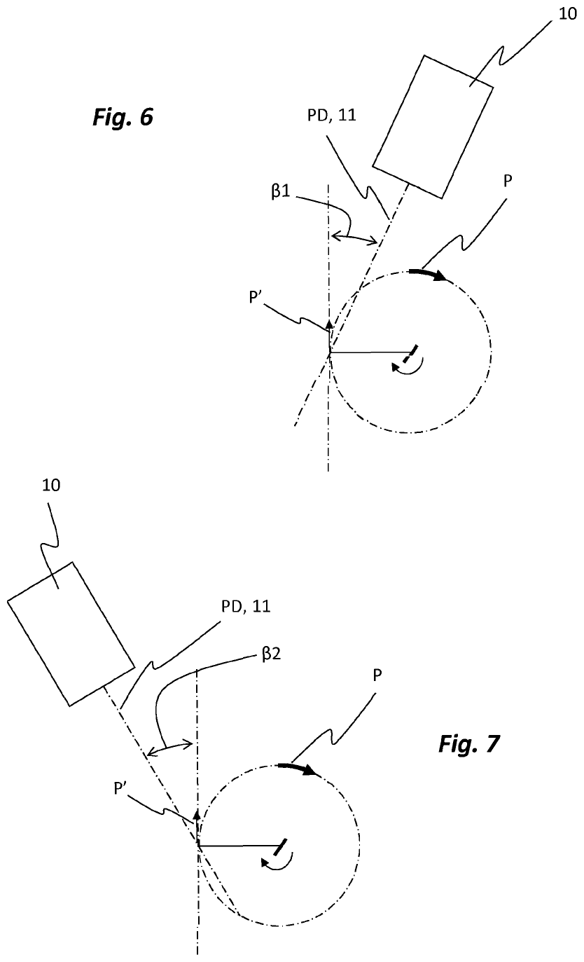

As shown in FIGS. 2 and 3, the focused laser beam 11 is directed such that the geometrical main propagation direction PD has a main component transverse to the longitudinal extension LE of respective bristle 4 having its end at the main irradiation spot 12. In the embodiment shown in FIGS. 2 and 3, the geometrical main propagation direction PD is orthogonal to the longitudinal extension LE of respective bristle 4 having its end at the main irradiation spot 12. In FIGS. 6 and 7, the focused laser beam 11 is oriented with its geometrical main propagation direction PD at different angles, not being orthogonal, but still having a main component transverse to the longitudinal extension LE of respective bristle 4 having its end at the main irradiation spot 12. A rounding 150 of the end is provided by the focused laser beam 11 heating the end and causing it to partly melt and form a rounded end

As shown in FIG. 4, the focused laser beam 11 is configured to move 160 the main irradiation spot 12 along the longitudinal axis L of the brush section 1′, thereby providing a relative motion between the main irradiation spot 12 and the brush section 1′ and thereby subjecting the ends of the plurality of bristles 4 to the focused laser beam 4 in sequence. It may be noted that the focused laser beam 11 is directed such that it does not hit the upper part of the brush section but instead shoots past the brush section with the main irradiation spot 12 positioned in a plane in front of the brush section 1′ or in a plane behind the brush section 1′ as shown in e.g. FIG. 2. Once the sequence 160 has been completed there is provided a brush section 1′ having end rounded bristles 4. It may be noted that the relative motion 160 between the main irradiation spot 12 and the brush section 1′ will be along a direction having a main component being transverse to the path P. In the shown embodiment, the relative motion 160 will be orthogonal to the path P.

In accordance with one embodiment the method further comprises end cutting 140 respective bristle 4 by a mechanical cutter 40 before rounding 150 of the end of respective bristle 4. This cutting may e.g. be performed by rotating the brush section 1′ about the longitudinal direction L with the bristles 4 sweeping against a knife edge 40, such as a razor blade 40. This is shown in FIG. 5. The knife edge may e.g. be movable between an active position where it cuts the bristles (shown in solid lines) and a non-active position (shown in dashed lines). After the bristles 4 has been cut by the cutter 40, the laser 10 is activated and the bristles 4 are end rounded 150.

In accordance with one embodiment the method comprises end cutting 140 respective bristle 4 by means of a focused laser beam 11 before rounding 150 of the end. This may e.g. be performed by a separate laser. However, if the end cutting is performed using a laser it is currently preferred that the method comprises using the same laser 10 for end cutting 140 and end rounding 150 whereby there is provided a relative motion of the focused laser beam 11 along the longitudinal axis L also for the end cutting operation 140 such that the plurality of bristles 4 are cut before there is provided a relative motion of the focused laser beam 11 along the longitudinal axis L for rounding of the ends of the bristles 4. This may e.g. be performed by a complete sweep along all the bristles 4 for the end cutting operation 140 followed by a complete sweep along all the bristles 4 for the end rounding operation 150. Alternatively, the end cutting 140 and end rounding 150 may be divided into portions such that initially a first portion including the bristles 4 along a portion of the longitudinal axis are cut 140 and then end rounded 150 where after the bristles 4 of a second portion are cut 140 and end rounded 150. Such a stepwise process may e.g. be useful if the relative motion is provided as a combination of a redirection of the focused laser beam 11 and a translational motion.

In accordance with one embodiment, the method further comprises end cutting 140 respective bristle 4 by means of a focused laser beam 11 while the end is heated to be rounded 150. This may e.g. be accomplished by using the laser 10 to both end cut 140 and end round 150 the end of the respective bristle 4. This simultaneous end cutting 140 and end rounding 150 is indicated by the dashed bracket in FIG. 8.

As shown in FIG. 5, the method further comprises positioning the brush section 1′ in a first fixture 21 comprising a first part 21a and a second part 21b and keeping the brush section 1′ in the first fixture 21a, 21b during both the end cutting 140 and the end rounding 150 of the end of respective bristle 4. This fixture 21, with its parts 21a, 21b, is also used to perform the twisting of the stem 3. The fixture part 21a grabs the two strands of the stem 3 and the fixture part 21b grabs the folded end. A relative rotation of the fixture parts 21a and 21b will cause the part of the stem 3 between the fixture parts 21a, 21b to be twisted.

It may however be noted that in accordance with an alternative, the brush section 1′ may be gripped by a first fixture 21 during end cutting and then be transferred to another fixture 21 holding the brush section 1′ in place during the end rounding 150.

In FIGS. 2 and 3, the main propagation direction PD of the focused laser beam 11 is directed such that it is parallel to but in the opposite direction of a tangent P′ of the circular path P in the main irradiation spot 12. In FIG. 4, it is shown how the angle of the main propagation direction PD is altered from a first angle α1 of slightly less than 45° on a first side to a second angle α2 of slightly less than 45° on a second side of the tangent P′ of the path P, with the angles measured between the tangent P′ of the path P in the main irradiation spot 12 and the main propagation direction PD. It may be noted that in FIG. 4, the angle α is used to provide a sweep of the focused laser beam 11. It is also conceivable that the laser beam 11 is provided at a fixed angle α and that the brush section 1′ and/or the laser source 10 is moved along the longitudinal axis L. It is also conceivable to use a combination of a sweeping of the focused laser beam 11 as shown in FIG. 2 and a relative translational motion. The angle α is measured in a plane defined by the longitudinal axis L and the tangent P′ of the circular path P in the main irradiation spot 12.

In FIGS. 6 and 7, there is shown how the main propagation direction PD of the focused laser beam 11 is directed such that it forms an angle β in a defined by the circular path P relative to the tangent P′ of the circular path P in the main irradiation spot 12. In FIGS. 6 and 7, the plane defined by the circular path P is parallel to the plane of the paper. Both angles β1 and β2 are less than 45° and preferably less than 30°.

It may be noted that the focused laser beam 11 may be inclined as discussed above with both an angle α and an angle β. One or both angles may be fixed and/or one or both angles may be actively changed during the end rounding.

It may be noted that it is also conceivable that the focused laser beam 11 may be directed such that the main propagation direction PD and the tangent P′ of the circular path P in the main irradiation spot 12 are directed in the same direction.

Thus it is preferred that the focused laser beam 11 is directed relative to the tangent P′ of the circular path P in the main irradiation spot 12 basically within an hour glass shaped double cone with the side surfaces forming an angle of up to 45° relative to the centre line formed by the tangent P′ of the circular path P in the main irradiation spot 12.

The focused laser beam 11 has a maximum intensity of 10-20000 W/mm² at the geometrical focus spot.

The focused laser beam 11 has a focus spot having an area of 0.01 to 1 mm².

The focused laser beam 11 has preferably a circular focus spot or a focus spot at least having a maximum width being less than 2 times a width in a direction orthogonal to the maximum width.

The focused laser beam 11 has a wavelength of 300 to 11000 nm.

The focused laser beam 11 has a focus depth of between 100 to 10000 μm. The focus depth being defined as a distance measured along the propagation direction between two spots 12′ and 12″, one on either side of the geometrical focus spot along the propagation direction, at which spots 12′, 12″ the intensity per surface area is 95% of the intensity per surface area at the geometrical focus spot. In FIG. 3, there is shown a focus spot 12′″ with an alternative geometry. The focus spot 12′″ has a maximum width w1 being slightly less than two times the minimum width w2.

When performing the end rounding, the respective bristle end is subjected to the focused laser beam for a time period being between 100-100000 μs, preferably between 100 and 10000 μs, thereby heating the end and causing it to partly melt. This may e.g. be accomplished by rotating the bristle section 1′ about the longitudinal axis at a rotational speed of between about 100 and about 10000 revolutions per minute and with the main irradiation sport 12 being a distance R being between about 0.5 mm to 10 mm from the rotational axis L, thereby giving the end of the bristle 4 a tangential speed of between about 0.01 to 10 m/s along the tangent P′ of the path P.

It may be noted that when the focused laser beam 11 is directed relative to the tangent P′ and relative to the direction of rotation as shown in FIG. 6, a smaller amount of energy from the laser beam 11 is applied to the bristle 4 before the bristle 4 reaches the main irradiation spot 12 than the amount of energy applied to the bristle 4 after the bristle 4 has passed the main irradiation spot 12. This may be referred to as an after-heating the bristle ends.

It may be noted that when the focused laser beam 11 is directed relative to the tangent P′ and relative to the direction of rotation as shown in FIG. 7, a greater amount of energy from the laser beam 11 is applied to the bristle 4 before the bristle 4 reaches the main irradiation spot 12 than the amount of energy applied to the bristle 4 after the bristle 4 has passed the main irradiation spot 12. This may be referred to as a pre-heating the bristle ends.

In FIG. 9, there is schematically shown a bristle 4 with an end being end rounded in accordance with the method and apparatus disclosed above.

As noted in FIG. 9, the end rounding will basically result in a drop-like shape being formed at the end of the bristle 4. The drop-like shape of the rounded end has a maximum extension D along a radial direction of the bristle extending between 1.1 and 2 times, preferably between 1.1 and 1.5 times, the maximum extension d of an unaffected part of the bristle 4. The unaffected part of the bristle 4 is typically circular in cross-section and the maximum extension is basically a diameter d. The drop-like shape is typically circular in cross-section and the maximum extension is basically a diameter D.

The drop-like shape of the rounded end has an extension H along the longitudinal extension LE the bristle 4 being between 1.1 and 2 times, preferably between 1.1 and 1.5 times, the maximum extension d of an unaffected part of the bristle 4.

The bristles 4 are preferably made of polyamide or polyester. The respective bristle 4 has preferably a diameter between about 0.03 to 0.2 mm.

It is contemplated that there are numerous modifications of the embodiments described herein, which are still within the scope of the invention as defined by the appended claims.

1. Method for end rounding bristles of a brush section comprising a plurality of bristles, the method comprising
providing a focused laser beam propagating along a geometrical main propagation direction and having a main irradiation spot,
providing a relative motion between an end of each bristle and the main irradiation spot of the focused laser beam such that the end of each bristle is moved through the main irradiation spot in a path having a main component transverse to a longitudinal extension of the bristle, wherein the focused laser beam is directed such that the geometrical main propagation direction has a main component transverse to the longitudinal extension of respective bristle having its end at the main irradiation spot, whereby a rounding of the end is provided by the focused laser beam heating the end and causing it to partly melt and form a rounded end,
providing a relative motion between the main irradiation spot and the brush section along a direction having a main component being transverse to the path, thereby subjecting in sequence the ends of the plurality of bristles to the focused laser beam thereby providing a brush section having end rounded bristles.

2. Method according to claim 1, the method further comprising end cutting respective bristle by a mechanical cutter before rounding of the end.

3. Method according to claim 1, the method further comprising end cutting respective bristle by means of a focused laser beam before rounding of the end.

4. Method according to claim 1, the method further comprising end cutting respective bristle by means of a focused laser beam while the end is heated to be rounded.

5. Method according to any one of claim 2, the method further comprising positioning the brush section in a first fixture and keeping the brush section in the first fixture during both the end cutting and the end rounding of the ends.

6. Method according to claim 1, wherein the brush section is an interdental brush section, the method further comprising:
providing the interdental brush section comprising a brush stem extending along a longitudinal axis and a plurality of bristles supported by the stem and extending from the stem in a mainly radial direction,
wherein the step of providing a relative motion between an end of each bristle and the main irradiation spot of the focused laser beam, comprises rotating the interdental brush section about the longitudinal axis such that an end of each bristle sweeps around the longitudinal axis whereby the path in which the end of each bristle is moved through the main irradiation spot becomes a circular path in which circular path the end passes the main irradiation spot,
wherein the step of providing a relative motion between the main irradiation spot and the brush section, comprises providing a relative motion of the main irradiation spot along the longitudinal axis thereby subjecting the ends of the plurality of bristles to the focused laser beam in sequence thereby providing a brush section having end rounded bristles.

7. Method according to claim 6, the method further comprising directing the focused laser beam such that the geometrical main propagation direction forms an angle of up to 45° relative to a tangent of the circular path in the main irradiation spot.

8. Method according to claim 6, the method further comprising end cutting respective bristle by means of a focused laser beam by providing a relative motion of the focused laser beam along the longitudinal axis thereby end cutting the plurality of bristles before providing a relative motion of the focused laser beam along the longitudinal axis for rounding of the ends.

9. Method according to claim 1, wherein the focused laser beam has a maximum intensity of 10-20000 W/mm² at the geometrical focus spot.

10. Method according to claim 1, the method further comprising focusing the focused laser beam to a geometrical focus spot having an area of 0.01 to 1.0 mm².

11. Method according to claim 1, the method further comprising focusing the focused laser beam to a geometrical focus spot having a maximum width being less than two times a width in a direction orthogonal to the maximum width.

12. Method according to claim 1, further comprising focusing the focused laser beam to a focus depth of between 100 to 10000 μm.

13. Method according to claim 1, further comprising subjecting respective bristle end to the focused laser beam for a time period being between 100-100000 μs, thereby heating the end and causing it to partly melt.

14. Apparatus for end rounding bristles of a brush section comprising a plurality of bristles, the apparatus comprising:
a laser comprising a laser beam source and optics configured to provide a focused laser beam propagating along a geometrical main propagation direction and having a main irradiation spot,
a fixture for holding a brush section comprising a plurality of bristles, wherein the fixture is configured to provide a relative motion between an end of each bristle and the main irradiation spot of the focused laser beam such that the end of each bristle is moved through the focused laser beam at the main irradiation spot in a path having a main component transverse to a longitudinal extension of the bristle,
wherein the focused laser beam is directed such that the geometrical main propagation direction has a main component transverse to the longitudinal extension of respective bristle having its end at the main irradiation spot, whereby a rounding of the end is provided by the focused laser beam heating the end and causing it to partly melt and form a rounded end,
wherein the apparatus is configured to provide a relative motion between the main irradiation spot and the brush section along a direction having a main component being transverse to the path, thereby subjecting the ends of the plurality of bristles to the focused laser beam in sequence thereby providing a brush section having end rounded bristles.

15. Apparatus according to claim 14,
wherein the fixture is configured to rotate the brush section about a longitudinal axis such that an end of each bristle sweeps around the longitudinal axis in a circular path,
wherein the laser is oriented relative to the fixture such that the focused laser beam becomes directed towards the bristles of a brush section in the fixture such that an end of respective bristle sweeping in the circular path passes the main irradiation spot, and
wherein the apparatus is configured to provide a relative motion between the fixture and the main irradiation spot along the longitudinal axis such that the focused laser beam becomes directed towards the respective end of the plurality of bristles in sequence.
